(19) United States
(12) Patent Application Publication
(10) Pub. No.: US 2016/0148614 A1
(43) Pub. Date: May 26, 2016

(54) SPEECH RECOGNITION SYSTEM AND SPEECH RECOGNITION METHOD

(71) Applicant: HYUNDAI MOTOR COMPANY, Seoul (KR)

(72) Inventors: Hyunjin YOON, Suwon-si (KR); Chang Heon LEE, Yongin-si (KR)

(21) Appl. No.: 14/943,722

(22) Filed: Nov. 17, 2015

(30) Foreign Application Priority Data
Nov. 26, 2014 (KR) 10-2014-0166789

(51) Int. Cl. G10L 15/22; G10L 25/18; G10L 21/0232; G10L 25/84; G10L 25/48

(52) U.S. Cl. CPC G10L 15/22; G10L 25/84; G10L 25/48; G10L 21/0232; G10L 25/18; G10L 2015/223

(57) ABSTRACT

A speech recognition system includes a transfer function storage storing a vehicle transfer function, which represents an acoustic environment in a vehicle and frequency response characteristic of a microphone; a signal-to-noise ratio (SNR) estimator estimating an SNR of an input signal received from the microphone; a speech section determiner determining a speech section to which the vehicle transfer function is applied based on the SNR; a frequency pattern extractor extracting a feature pattern of the speech signal of which the frequency distortion is compensated; and a speech recognition engine recognizing a speech command by using the feature pattern.

### CROSS-REFERENCE TO RELATED APPLICATION

This application claims the benefit of priority to Korean Patent Application No. 10-2014-0166789 filed in the Korean Intellectual Property Office on Nov. 26, 2014, the entire content of which is incorporated herein by reference.

### TECHNICAL FIELD

The present disclosure relates to a speech recognition system and a speech recognition method.

### BACKGROUND

A human-machine interface (HMI) interfaces a user with a machine through visual sensation, auditory sensation, or tactile sensation.

Attempts have been made to use speech recognition for the HMI within a vehicle in order to minimize diversion of a driver's attention and to improve user convenience.

According to a speech recognition system in a vehicle, a speech signal is affected by acoustic environment in the vehicle and frequency response characteristic of a microphone while speech of a user (e.g., driver) is transmitted to the speech recognition system through the microphone. As a result, a speech signal in a partial frequency section may be amplified or attenuated. In addition, when noise is excessively removed by a post-filter interlocking with a noise removal algorithm, a speech component is partially lost, and hence, speech recognition performance may be deteriorated.

Accordingly, in order to improve speech recognition performance of the speech recognition system in the vehicle, it is necessary to compensate speech component distorted by the acoustic environment in the vehicle and the frequency response characteristic without excessively removing noise.

An attenuation of the input signal is variable by a distance between a mouth of the user and the microphone, and an attenuation degree may be variable for each frequency band. According to a conventional speech recognition system using the microphone as a speech input means, an additional distance sensor is needed for compensating frequency distortion generated due to frequency response characteristic of the microphone, and thus, production cost of the speech recognition system increases. In an environment having much noise, such as in vehicle driving, it is difficult to measure the frequency response characteristic of the microphone and difficult to compensate distortion due to acoustic environment in the vehicle.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a speech recognition system and a speech recognition method having advantages of improving speech recognition performance.

A speech recognition system according to an exemplary embodiment of the present inventive concept includes a transfer function storage storing a vehicle transfer function, which represents an acoustic environment in a vehicle and a frequency response characteristic of a microphone; a signal-to-noise ratio (SNR) estimator estimating an SNR of an input signal received from the microphone; a speech section determiner determining a speech section to which the vehicle transfer function is applied based on the SNR; a frequency distortion compensator compensating for frequency distortion of a speech signal included in the speech section by using the vehicle transfer function; a feature pattern extractor extracting a feature pattern of the speech signal of which the frequency distortion is compensated; and a speech recognition engine recognizing a speech command by using the feature pattern.

The speech section to which the vehicle transfer function is applied may be a region at which a gain of the speech signal is equal to or greater than a threshold value, and the speech section determiner may set the threshold value based on the SNR.

The vehicle transfer function may be calculated by using a white noise.

The vehicle transfer function may be calculated based on the white noise and the input signal input to the speech recognition system from the microphone.

The frequency distortion compensator may compensate for the frequency distortion of the speech signal by inverse-compensating a gain of the speech signal included in the speech section through the vehicle transfer function.

The speech recognition system may further include: a frequency transformer transforming the input signal into a signal in a frequency domain; a noise remover removing a noise component from the signal in the frequency domain received from the frequency transformer; and an inverse frequency transformer transforming the speech signal received from the frequency distortion compensator into a signal in a time domain and outputting the signal in the time domain to the feature pattern extractor.

A speech recognition method of a speech recognition system according to another exemplary embodiment of the present inventive concept includes transforming, by a frequency transformer, an input signal received from a microphone into a signal in a frequency domain; estimating, by a signal-to-noise ratio (SNR) estimator, a signal-to-noise ratio (SNR) of the signal in the frequency domain; determining, by a speech section determiner, a speech section to which a vehicle transfer function is to be applied based on the SNR; compensating, a frequency distortion compensator, for frequency distortion of a speech signal included in the speech section by using the vehicle transfer function; extracting, by a feature pattern extractor, a feature pattern of the speech signal of which the frequency distortion is compensated; and recognizing, by a speech recognition engine, a speech command by using the feature pattern.

The speech section to which the vehicle transfer function is to be applied may be a region at which a gain of the speech signal is equal to or greater than a threshold value, and the threshold value may be set based on the SNR.

The vehicle transfer function may be calculated by using white noise.

The vehicle transfer function may be calculated based on the white noise and an input signal input to the speech recognition system from the microphone.

In the compensating for the frequency distortion of the speech signal included in the speech section by using the vehicle transfer function, the frequency distortion of the speech signal may be compensated for by inverse-compensating a gain of the speech signal included in the speech section through the vehicle transfer function.

The speech recognition method may further include: removing a noise component from the signal in the frequency; and transforming the speech signal of which the frequency distortion is compensated into a signal in a time domain by performing inverse frequency transformation.

### BRIEF DESCRIPTION OF THE DRAWINGS

FIG. 1 is a block diagram of a speech recognition system according to an exemplary embodiment of the present inventive concept.

FIG. 2 is a block diagram of a transfer function calculating device according to an exemplary embodiment of the present inventive concept.

FIG. 3 is a graph for explaining a method of calculating a vehicle transfer function according to an exemplary embodiment of the present inventive concept.

FIG. 4 is a flowchart of a speech recognition method of a speech recognition system according to an exemplary embodiment of the present inventive concept.

### DETAILED DESCRIPTION OF THE EMBODIMENTS

Hereinafter, the present disclosure will be described more fully with reference to the accompanying drawings, in which exemplary embodiments are shown. As those skilled in the art would realize, the described embodiments may be modified in various different ways, all without departing from spirit or scope of the present disclosure.

Since each component shown in the drawings is arbitrarily illustrated for easy description, the present disclosure is not particularly limited to the components illustrated in the drawings.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicle, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that the below method are executed by at least one controller. The term “controller” refers to a hardware device that includes a memory and a processor configured to execute one or more steps that should be interpreted as its algorithm structure. The memory is configured to store algorithmic steps and the processor is specifically configured to execute said algorithmic steps to perform one or more processes which are described further below.

Furthermore, the control logic in the present disclosure may be embodied as non-transitory computer readable media on a computer readable medium containing executable program instructions executed by a processor, controller or the like. Examples of the computer readable mediums include, but are not limited to, ROM, RAM, compact disc (CD-ROMs, magnetic tapes, floppy disks, flash drives, smart cards and optical data storage devices.

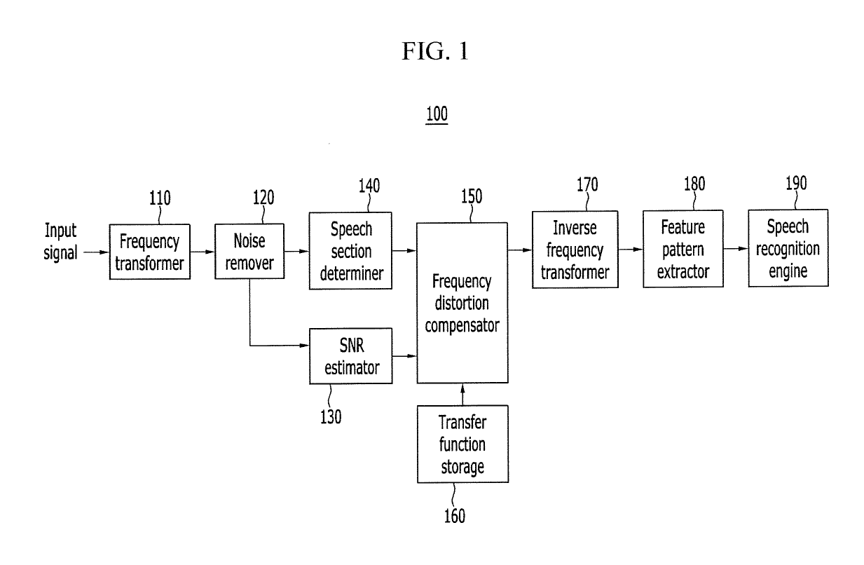

Hereinafter, a speech recognition system and a speech recognition method according to an exemplary embodiment of the present invention will be described in detail with reference to FIG. 1 to FIG. 4.

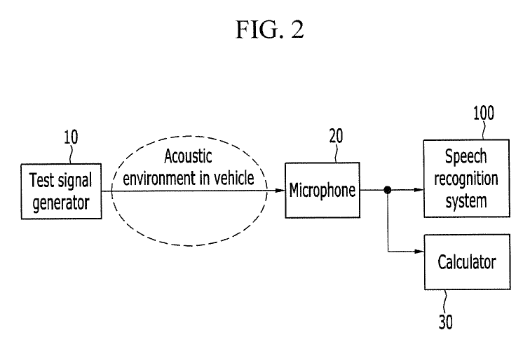

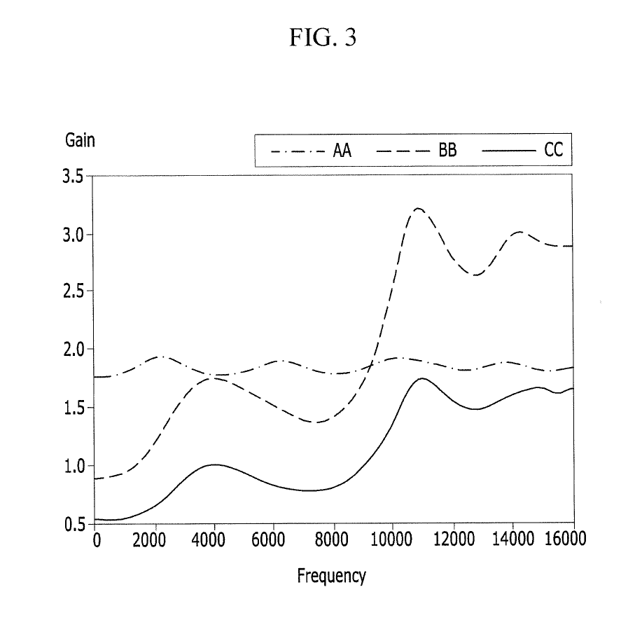

FIG. 1 is a block diagram of a speech recognition system according to an exemplary embodiment of the present inventive concept, FIG. 2 is a block diagram of a transfer function calculating device according to an exemplary embodiment of the present inventive concept, and FIG. 3 is a graph for explaining a method of calculating a vehicle transfer function according to an exemplary embodiment of the present inventive concept.

Referring to FIG. 1, a speech recognition system 100 according the present disclosure may include a frequency transformer 110, a noise remover 120, a signal-to-noise ratio (SNR) estimator 130, a speech section determiner 140, a frequency distortion compensator 150, a transfer function storage 160, an inverse frequency transformer 170, a feature pattern extractor 180, a speech recognition engine 190. When the constituent elements are implemented in actual application, two or more constituent elements may be into on constituent element, or one constituent element may be subdivided into two or more constituent elements if necessary for configuration.

When an input signal is received from a microphone 20 (referring to FIG. 2), the frequency transformer 110 transforms the input signal into a signal in a frequency domain by performing a fast Fourier transform (FFT).

The noise remover 120 removes a noise component from the signal in the frequency domain received from the frequency transformer 110.

The SNR estimator 130 estimates an SNR of the input signal.

When the input signal from which the noise component is removed is received from the noise remover 120, the speech section determiner 140 determines a section (hereinafter, referred to as speech section) at which a speech signal is present in the frequency domain. The speech section determiner 140 may make different a degree of determining the speech section based on the SNR estimated by the SNR estimator 130.

The frequency distortion compensator 150 may compensate for a frequency distortion of a signal (hereinafter, referred to as speech signal) included in the speech section by using a vehicle transfer function stored in the transfer function storage 160.

The vehicle transfer function is a transfer function corresponding to a gain change in the frequency domain until speech of a user in a vehicle is transmitted to the speech recognition system 100. The vehicle transfer function reflects a distortion characteristic that is generated while the speech of the user is passed through acoustic environment in the vehicle and the microphone 20. In other words, the vehicle transfer function represents the acoustic environment in the vehicle and a frequency response characteristic of the microphone 20.

The vehicle transfer function may be calculated based on a gain change in the frequency domain until the a test signal, that is white noise, is input to the speech recognition system 100 after the test signal is passed through the acoustic environment in the vehicle and the microphone 20.

Referring to FIG. 2, a transfer function calculating device according to the present disclosure may include a test signal generator 10, the microphone 20, and a calculator 30.

The test signal generator 10 may include a sound output means such as a speaker, and may generate the test signal that is the white noise. The test signal generator 10 may be installed at a position corresponding to a mouth of a driver in the vehicle.

The test signal generated by the test signal generator 10 is input to the microphone 20 after passing through the acoustic environment in the vehicle.

The microphone 20 receives the test signal generated by the test signal generator 10. The test signal is transmitted to the speech recognition system 100 from the microphone 20 as an input signal.

The calculator 30 calculates the vehicle transfer function based on the test signal and the input signal input to the speech recognition system 100 from the microphone 20. In detail, the calculator 30 may calculate a gain change between the test signal and the input signal in the frequency domain.

Referring to FIG. 3, a test signal AA is indicated by one-point chain lines, an input signal BB is indicated by dotted lines, and a vehicle transfer function CC is indicated by solid lines. The test signal AA that is white noise is influenced by the acoustic environment in the vehicle and the frequency response characteristic of the microphone 20, thereby changing a gain of the input signal BB in the frequency domain. Accordingly, the gain of the input signal BB input to the speech recognition system 100 is different from a gain of the test signal AA in the frequency domain. The transfer function calculating device may calculate the transfer function CC by comparing the test signal AA and the input signal BB.

The vehicle transfer function calculated by the transfer function calculating device is stored in the transfer function storage 160 of the speech recognition system 100 and is used to compensate for the frequency distortion of the speech signal.

The frequency distortion compensator 150 reads the vehicle transfer function stored in the transfer function storage 160 and compensates for the frequency distortion of the speech signal by inverse-compensating the speech signal through the vehicle transfer function.

Equation 1 represents a method for calculating a gain G_{P} of a signal of which a frequency distortion is compensated by inverse-compensating for a gain G_{voice} of a speech signal in a speech section by using the vehicle transfer function TF_{car}.

$${G}_{p} = \{ \begin{matrix}\frac{{G}_{Voice}}{{TF}_{car}} , & when {G}_{Voice} \geq {G}_{TR} \\ 1 , & when {G}_{Voice} < {G}_{TR}\end{matrix} \qquad [ Equation 1 ]$$

In the above equation, G_{voice} represents a gain of a speech signal in the frequency domain, and may have a value between 0 and 1. As the G_{voice} becomes closer to 1, a probability that a speech component exists becomes higher. G_{TR} is a threshold value for determining a speech section to which the vehicle transfer function is applied. The speech section determiner 140 may set G_{TR} based on the SNR estimated by the SNR estimator 130.

The SNR is decreased as the noise component of the input signal is increased. Even though the noise component is primarily removed by the noise remover 120, some noise component may remain. Thus, a frequency region, at which a difference between a gain of a noise section and a gain of a speech section is small, may be increased. In this case, the speech section may be wrongly determined as the noise section. Accordingly, when the SNR is less than a reference value, the speech section determiner 140 reduces the threshold value G_{TR} to prevent the speech section from being lost.

In contrast, the SNR is increased as the noise component of the input signal is decreased. In this case, a frequency region at which a difference between a gain of a noise section and a gain of a speech section is large may be increased. When the SNR is equal to or greater than the reference value, the speech section determiner 140 increases the threshold value G_{TR}, and as a result, a speech section to which the vehicle transfer function is applied (i.e., a region for which a frequency distortion is compensated) may be clearly determined.

As described above, when the speech section to which the vehicle transfer function is to be applied is determined, the frequency distortion compensator 150 compensates for the frequency distortion of the speech signal by inverse-compensating the gain of the speech signal included in the speech section through the vehicle transfer function TF_{car}.

When the speech signal of which the frequency distortion is compensated is received from the frequency distortion compensator 130, the inverse frequency transformer 170 transforms the speech signal in the frequency domain into a signal in a time domain by performing inverse frequency transformation and then outputs the signal in the time domain to the feature pattern extractor 180.

When the speech signal in the time domain is received from the inverse frequency transformer 170, the feature pattern extractor 180 extracts a feature pattern of the speech signal.

The speech recognition engine 190 recognizes a speech command of the user by using the feature pattern extracted by the feature pattern extractor 180. Speech-based devices may be controlled based on the speech command (i.e., a speech recognition result). For example, a function (e.g., a call function or a route guidance function) corresponding to the recognized speech command may be executed.

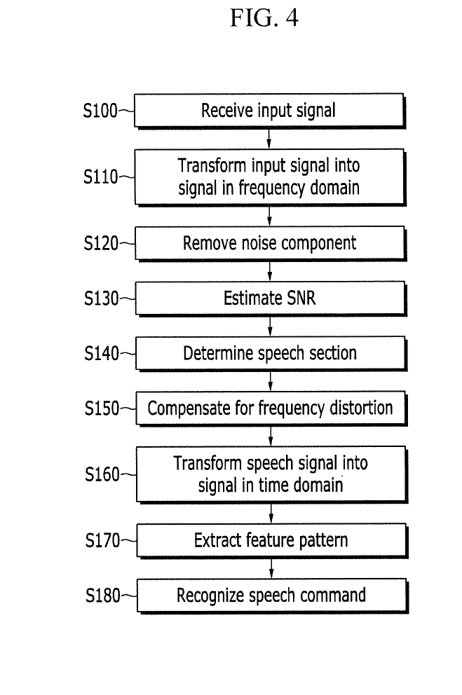

FIG. 4 is a flowchart of a speech recognition method of a speech recognition system according to an exemplary embodiment of the present inventive concept.

As shown in FIG. 4, the speech recognition system 100 may receive the input signal from the microphone 20 at step S100.

The frequency transformer 110 may transform the input signal into a signal in the frequency domain at step S110.

The noise remover 120 may remove a noise component of the signal in the frequency domain at step S120.

The SNR estimator 130 may estimate the SNR of the signal from which the noise component is removed in the frequency domain at step S130.

When the input signal from which the noise component removed is received from the noise remover 120, the speech section determiner 140 determines the speech section to which the vehicle transfer function is to be applied based on the SNR at step S140.

When the speech section to which the vehicle transfer function is to be applied is determined by the speech section determiner 140, the frequency distortion compensator 150 compensates for the frequency distortion of the speech signal by inverse-compensating the gain of the speech signal included in the speech section by using the vehicle transfer function at step S150.

When the speech signal of which the frequency distortion is compensated is received from the frequency distortion compensator 130, the inverse frequency transformer 170 transforms the speech signal into a signal in the time domain by performing inverse frequency transformation at step S160.

When the speech signal transformed into the time domain is received from the inverse frequency transformer 170, the feature pattern extractor 180 extracts the feature pattern of the speech signal at step S170.

The speech recognition engine 190 recognizes a speech command by using the feature pattern extracted by the feature pattern extractor 180 at step S180.

As described above, in the present disclosure, the vehicle transfer function may be calculated using the test signal that is the white noise, and the frequency distortion generated due to the acoustic environment in the vehicle and the frequency response characteristic may be compensated for based on the vehicle transfer function. As a result, speech recognition performance may be improved

Particularly, speech recognition success rate of a user such as a non-native speaker vulnerable to the frequency distortion may be improved.

The accompanying drawings and the detailed description of the invention are only illustrative, and are used for the purpose of describing the present disclosure but are not used to limit the meanings or scope of the present disclosure described in claims. Therefore, a person skilled in the art may easily select and replace the exemplary embodiments. Further, those skilled in the art may omit a part of the constituent elements described in the present specification without deterioration of performance or add a constituent element for improving performance. In addition, those skilled in the art may change a sequence of the steps of the method described in the present specification according to a process environment or equipment. Accordingly, the scope of the present disclosure shall be determined by the accompanying claims and equivalents thereof, not the aforementioned exemplary embodiments.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A speech recognition system, comprising:
a transfer function storage storing a vehicle transfer function, which represents an acoustic environment in a vehicle and a frequency response characteristic of a microphone;
a signal-to-noise ratio (SNR) estimator estimating an SNR of an input signal received from the microphone;
a speech section determiner determining a speech section to which the vehicle transfer function is applied based on the SNR;
a frequency distortion compensator compensating for frequency distortion of a speech signal included in the speech section by using the vehicle transfer function;
a feature pattern extractor extracting a feature pattern of the speech signal of which the frequency distortion is compensated; and
a speech recognition engine recognizing a speech command by using the feature pattern.

2. The speech recognition system of claim 1, wherein the speech section to which the vehicle transfer function is applied is a region at which a gain of the speech signal is equal to or greater than a threshold value, and
the speech section determiner sets the threshold value based on the SNR.

3. The speech recognition system of claim 1, wherein the vehicle transfer function is calculated by using a white noise.

4. The speech recognition system of claim 3, wherein the vehicle transfer function is calculated based on the white noise and the input signal input to the speech recognition system from the microphone.

5. The speech recognition system of claim 1, wherein the frequency distortion compensator compensates for the frequency distortion of the speech signal by inverse-compensating a gain of the speech signal included in the speech section through the vehicle transfer function.

6. The speech recognition system of claim 1, further comprising:
a frequency transformer transforming the input signal into a signal in a frequency domain;
a noise remover removing a noise component from the signal in the frequency domain received from the frequency transformer; and
an inverse frequency transformer transforming the speech signal received from the frequency distortion compensator into a signal in a time domain and outputting the signal in the time domain to the feature pattern extractor.

7. A speech recognition method of a speech recognition system, the method comprising:
transforming, by a frequency transformer, an input signal received from a microphone into a signal in a frequency domain;
estimating, by a signal-to-noise ratio (SNR) estimator, a signal-to-noise ratio (SNR) of the signal in the frequency domain;
determining, by a speech section determiner, a speech section to which a vehicle transfer function is applied based on the SNR;
compensating, by a frequency distortion compensator, for frequency distortion of a speech signal included in the speech section by using the vehicle transfer function;
extracting, by a feature pattern extractor, a feature pattern of the speech signal of which the frequency distortion is compensated; and
recognizing, by a speech recognition engine, a speech command by using the feature pattern.

8. The speech recognition method of claim 7, wherein the speech section to which the vehicle transfer function is applied is a region at which a gain of the speech signal is equal to or greater than a threshold value, and the threshold value is set based on the SNR.

9. The speech recognition method of claim 7, wherein the vehicle transfer function is calculated by using a white noise.

10. The speech recognition method of claim 9, wherein the vehicle transfer function is calculated based on the white noise and the input signal received from the microphone.

11. The speech recognition method of claim 7, wherein in the step of compensating,
the frequency distortion of the speech signal is compensated for by inverse-compensating a gain of the speech signal included in the speech section through the vehicle transfer function.

12. The speech recognition method of claim 7, further comprising:
removing a noise component from the signal in the frequency domain; and
transforming the speech signal of which the frequency distortion is compensated into a signal in a time domain by performing inverse frequency transformation.
